(19) United States
(12) Patent Application Publication
(10) Pub. No.: US 2012/0159988 A1
(43) Pub. Date: Jun. 28, 2012

(54) DISPLAYING AN IMAGE WITH MULTIPLE CIRULAR BANDS

(75) Inventors: Anthony J. Baird, Farmington, UT (US); Bruce R. Needham, Farmington, UT (US)

(73) Assignee: PUZZLETS, LLC, Farmington, UT (US)

(21) Appl. No.: 13/338,223

(22) Filed: Dec. 27, 2011

Related U.S. Application Data
(60) Provisional application No. 61/427,427, filed on Dec. 27, 2010.

(51) Int. Cl. A44C 5/00; A44C 27/00; B23P 11/00; G09F 3/00

(52) U.S. Cl. 63/11; 63/3; 63/5.1; 40/299.01; 29/896.411

(57) ABSTRACT

An apparatus and method are disclosed for displaying an image with multiple circular bands. Two or more circular bands are included and sized to surround a portion of a body part. At least one image is included where each of the two or more circular bands includes a portion of the at least one image disposed on an exterior side of each circular band. The at least one image is formed when the two or more circular bands are positioned to be adjacent.

### CROSS-REFERENCES TO RELATED APPLICATIONS

This application claims the benefit of U.S. Provisional Patent Application Ser. No. 61/427,427 entitled “Apparatus and Method for Displaying an Image with Multiple Circular Bands” and filed on Dec. 27, 2010 for Anthony J. Baird, et al., which is incorporated herein by reference.

### FIELD OF THE INVENTION

This invention relates to bracelets and similar jewelry and more particularly relates to a combination of circular bands that combines to display an image.

### SUMMARY

The present invention has been developed in response to the present state of the art, and in particular, in response to the problems and needs in the art that have not yet been fully solved by currently available bracelets and jewelry. Accordingly, the present invention has been developed to provide an apparatus and method for displaying an image with multiple circular bands that overcome many or all shortcomings in the art.

The apparatus to display an image with multiple circular bands includes two or more circular bands sized to surround a portion of a body part. The apparatus includes at least one image. Each of the two or more circular bands includes a portion of the at least one image disposed on an exterior side of each circular band. The at least one image is formed when the two or more circular bands are positioned to be adjacent. In one embodiment, the at least one image is formed by rotating each of the two or more circular bands to a position relative to one another. In another embodiment, the at least one image is formed by placing each of the two or more circular bands in a particular order relative to one another.

In one embodiment, the at least one image is formed by placing each of the two or more circular bands adjacent to one another and connecting the bands together with a connection mechanism. In another embodiment, the connection mechanism includes shaping each of the two or more circular bands to interlock in a position adjacent to one another to form the at least one image. In a further embodiment, the two or more bands interlock by way of an extension and a recess, where an extension from a circular band of the two or more circular bands fits into a recess of an adjacent circular band.

In another embodiment, the connection mechanism includes an interlocking member that is separate from the two or more circular bands and that connects the two or more circular bands such that the two or more circular bands retain a relative position to one another to form the at least one image. The interlocking member is shaped to insert into an opening in each of the two or more circular bands, fasten to each of the two or more circular bands, and/or surround each of the two or more circular bands.

In one embodiment, each of the two or more circular bands includes a portion of two or more images. In a further embodiment, a first image is formed when the two or more circular bands are rotated to align portions of the two or more images and a second image is formed when the two or more circular bands are rotated to align different portions of the two or more images. In another embodiment, the at least one image includes a character, a picture, a design, a logo, and/or a slogan.

In one embodiment, one or more of the two or more circular bands includes at least a portion of an image on an interior side such that when a circular band with at least a portion of an image on the interior side is turned inside out, the at least a portion of the image on the interior side becomes at least a portion of an image on the exterior sides of the two or more circular bands. In another embodiment, the two or more circular bands have a non-slip surface on at least an interior side. In another embodiment, the two or more circular bands include a material that stretches.

In various embodiments, at least a portion of the two or more circular bands are constructed of silicone, rubber, plastic, wood, and/or metal. In one embodiment, each of the two or more circular bands also includes at least one extension piece, where each extension piece includes a portion of the at least one image. In a further embodiment, the extension pieces each include a connection mechanism wherein the connection mechanism connects such that the extension pieces are bound together.

Another apparatus of the present invention is also presented to display an image. The apparatus may be embodied by two or more bands sized to surround a portion of a body part, a connection mechanism that connects the two circular bands to be adjacent, and at least one image. Each of the two or more circular bands includes a portion of the at least one image disposed on a side of each circular band. The at least one image is formed when the two or more circular bands are connected with the connection mechanism to be adjacent.

A method of the present invention is also presented for displaying an image. The method in the disclosed embodiments substantially includes the steps necessary to carry out the functions presented above with respect to the operation of the described apparatuses. In one embodiment, the method includes forming two or more circular bands sized to surround a portion of a body part and forming on an exterior side of each of the two or more circular bands a portion of at least one image. The at least one image is formed when the two or more circular bands are positioned to be adjacent. In one embodiment, the method also includes connecting the two or more circular bands with a connection mechanism such that the two or more circular bands are adjacent and the at least one image is formed.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a perspective view illustrating one embodiment of an apparatus for displaying an image with multiple circular bands with the bands positioned apart in accordance with an embodiment of the present invention;

FIG. 1B is a perspective view illustrating one embodiment of an apparatus for displaying an image with multiple circular bands with the bands positioned together in accordance with an embodiment of the present invention;

FIG. 2 is a perspective view illustrating another embodiment of an apparatus for displaying an image with multiple circular bands with the bands positioned together and interlocking mechanisms holding the circular bands together in accordance with an embodiment of the present invention;

FIG. 3 is a perspective view illustrating another embodiment of an apparatus for displaying an image with multiple circular bands with the bands positioned together and an interlocking mechanism in accordance with an embodiment of the present invention;

FIG. 4 is a perspective view illustrating another embodiment of an apparatus for displaying an image with multiple circular bands with the image on a raised portion in accordance with an embodiment of the present invention;

FIG. 5 is a perspective view illustrating another embodiment of an apparatus for displaying an image with multiple circular bands with the image on a raised portion and a connecting mechanism in accordance with an embodiment of the present invention;

FIG. 6 is a perspective view illustrating one embodiment of an apparatus for displaying multiple images with a portion on each of multiple circular bands in accordance with an embodiment of the present invention;

FIG. 7A is a front view illustrating an embodiment of an apparatus for displaying images where a portion of each of multiple circular bands is shown in accordance with an embodiment of the present invention;

FIG. 7B is a back view illustrating an embodiment of an apparatus for displaying images where a portion of each of multiple circular bands is shown in accordance with an embodiment of the present invention;

FIG. 8 is a schematic block diagram illustrating one embodiment of a method for forming an image on two or more circular bands in accordance with the present invention;

FIG. 9 is a schematic block diagram illustrating another embodiment of a method for forming an image on two or more circular bands in accordance with the present invention;

FIG. 10A is a two dimensional view of one embodiment of a circular band for displaying an image on two or more circular bands in accordance with the present invention;

FIG. 10B is a two dimensional view of three circular bands connected together matching the circular band of FIG. 10A;

FIG. 10C is a perspective view of the circular band depicted in FIG. 10A;

FIG. 10D is an alternate perspective view of the circular band depicted in FIG. 10A;

FIG. 11A is a two dimensional view of one embodiment of three circular bands with three images on the circular bands in accordance with the present invention;

FIG. 11B is a two dimensional view of one embodiment of three circular bands with three images on the circular bands with the images rotated in accordance with the present invention;

FIG. 12 is a section view of two circular bands connected with an interlocking mechanism and three embodiments of the interlocking mechanism;

FIG. 13 is one embodiment of an apparatus for displaying an image with multiple puzzle pieces connected to a circular band in accordance with the present invention;

FIG. 14 is a two dimensional view of two circular bands connected together with an interlocking mechanism in a zigzag pattern in accordance with the present invention;

FIG. 15 is a two dimensional view of two circular bands connected together with an interlocking mechanism in a soccer ball pattern in accordance with the present invention;

FIG. 16 is a schematic block diagram of one embodiment of a system for customizing circular bands in accordance with the present invention;

FIG. 17 is a schematic block diagram of one embodiment of an apparatus for customizing circular bands in accordance with the present invention; and

FIG. 18 is a schematic block diagram illustrating another embodiment of a method for customizing circular bands in accordance with the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Aspects of the present invention are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

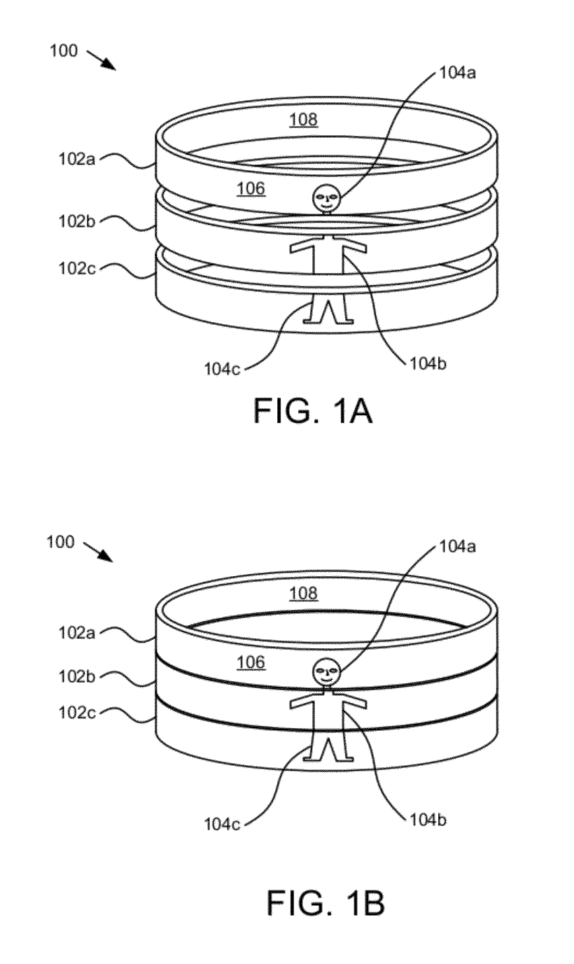

FIGS. 1A and 1B are a perspective view illustrating one embodiment of an apparatus 100 for displaying an image 104 with multiple circular bands 102 where FIG. 1A depicts the circular bands 102 positioned apart and FIG. 1B depicts the circular bands 102 positioned together, in accordance with an embodiment of the present invention. In one embodiment, the circular bands 102 are sized as bracelets to be worn on a wrist, arm, ankle, and the like. In others embodiments, the circular bands 102 are sized as a necklace, arm band, etc. and may be sized to wear on any body part. The circular bands 102 include an exterior side 106 and an interior side 108. Typically the interior side 108 is positioned next to a body part and the exterior side 106 faces away from the body part.

The circular bands 102, in one embodiment, are made of a material that stretches, such as rubber, silicone, and the like. In various embodiments, the circular bands 102 have at least a portion that stretches. In other embodiments, the circular bands 102 may be made of plastic, metal, wood, fabric, knotted or woven string or fibers, or any other material suitable for forming a circular band 102. In one embodiment, the circular bands 102a, 102b, 102c are equally sized. In another embodiment, the circular bands 102a, 102b, 102c are differently sized. For example, one circular band 102b may be wider (the vertical dimension in FIGS. 1A, 1B) than another circular band 102a, 102c.

The circular bands 102 may be hinged, may stretch, may have a suitably sized gap, may have a clasp, or any other means to position the circular bands 102 around a body part and then allow the circular bands 102 to remain on the body part. In some embodiments, the circular bands 102 may be positioned on a body part and then may remain in place. In other embodiments, the circular bands 102 may fit loosely on a body part and may move either slightly or a lot. Various embodiments may have circular bands 102 formed in any way to be positioned on a body part such that the multiple circular bands 102 display one or more images 104.

In other embodiments, the circular bands 102 may be in other shapes. As used herein, the term “circular band” is defined as a band that encircles something, such as a body part, and is not intended to limit the shape of the band. For example, a circular band (e.g. 102a) may be square, rectangular, or may be in any other shape when viewed from a top or bottom view or angle that shows the circular band 102 starting at one point and concluding at the same point. The circular band 102 may be in one shape, such as a square when not on a body part and may assume another shape when positioned around a body part.

In addition, a circular band 102 may have a cross section in various shapes. For example, the circular bands 102a, 102b, 102c depicted in FIG. 1A have a cross section in the form of a rectangle. Other possible shapes of a cross section of a circular band 102 may include a circle, a square, an oval, an irregular shape, etc. One of skill in the art will recognize other shapes of circular bands 102 capable of having a portion of an image 104a, 104b, 104c such that when the circular bands 102 are positioned adjacent they form an image 104.

In one embodiment, each of two or more circular bands 102 includes a portion of at least one image 104 such that when the circular bands 102 are positioned together the image 104 is formed. FIG. 1A depicts three circular bands 102a, 102b, and 102c (collectively “102”). Each circular band 102a, 102b, 102c includes a portion of an image 104a, 104b, 104c such that when the circular bands 102a, 102b, 102c are positioned together, the image 104 is formed.

While FIG. 1A depicts three circular bands 102a, 102b, 102c, the embodiments depicted herein are not intended to be limiting to three circular bands 102, and two, three, four, or more circular bands 102 may each have a portion of one or more images 104, such that when the circular bands 102 are positioned together an image 104 is formed.

FIG. 1A depicts an image 104 of a character, such as a cartoon character, drawing of a person, etc. In other embodiments, the image 104 may be a logo, a phrase, a nature scene, a picture, a design, or any other image 104. One of skill in the art will recognize other images 104 that may be formed on two or more circular bands 102. FIG. 1A depicts a head 104a on a first circular band 102a, a torso and arms 104b on a second circular band 102b, an legs 104c on a third circular band 102c. FIG. 1B shows that when the circular bands 102a, 102b, 102c are positioned together, the image of the character 104 is formed. Note that in the depicted embodiment of FIGS. 1A and 1B, to form the image 104, an order of the circular bands 102a, 102b, 102c creates an image 104 of a character. In other embodiment, one order of the circular bands 102 forms one or more images 104 and a different order of the circular bands 102 forms one or more alternate images 104.

In one embodiment, each circular band 102a, 102b, 102c includes an order indicator. For example, each circular band 102a, 102b, 102c may include a number or letter to indicate order. In another embodiment, order is indicated by a portion of a figure on each circular band 102a, 102b, 102c. One of skill in the art will recognize other mechanisms to indicate order.

In one embodiment, when the circular bands 102a, 102b, 102c are positioned next to each other, the circular bands 102 are then rotated to align the portions of the images 104a, 104b, 104c into an image 104. In another embodiment, once the circular bands 102a, 102b, 102c are rotated, the circular bands 102a, 102b, 102c are held in place relative to each other. In a further embodiment, each circular band 102 includes a surface on the interior side 108 that that is a non-slip surface. For example, the interior side 108 may include a rubber or other substance that has a high amount of friction when placed against skin, clothing, etc. In various embodiments, the non-slip surface is inherent in the material of the circular bands 102, is a different substance than the bulk of the circular bands 102, is formed onto the circular bands 102, is shaped with points or bumps, etc. One of skill in the art will recognize other ways to form a non-slip surface on an interior side 108 of the circular bands 102.

Portions of an image 104a, 104b, 104c may be included with the circular bands 102 in various ways. The portions of the image 104a, 104b, 104c may be printed, attached, glued, inlaid, or otherwise affixed to the circular bands 102.

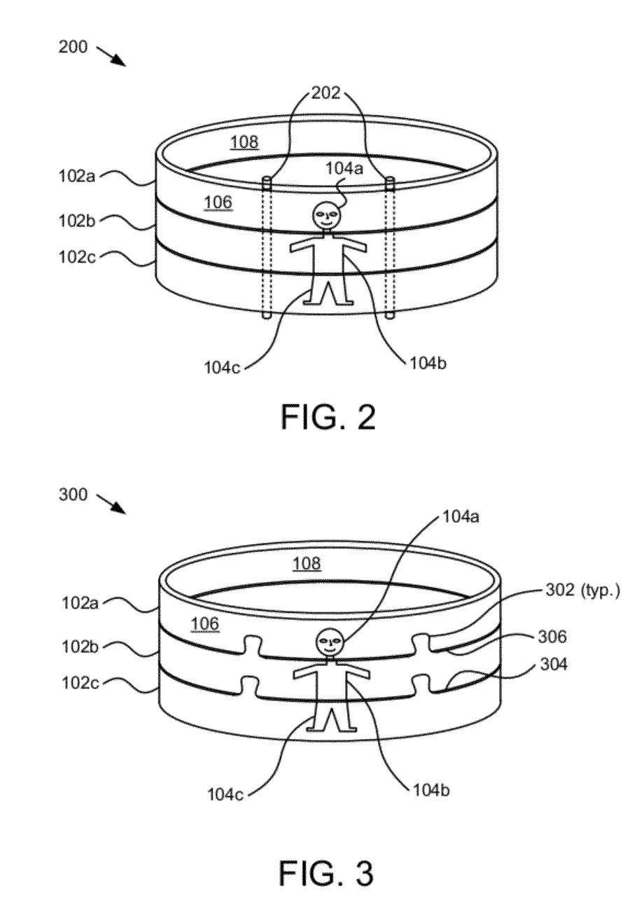

FIG. 2 is a perspective view illustrating another embodiment of an apparatus 200 for displaying an image 104 with multiple circular bands 102 with the bands positioned together and connecting mechanisms 202 holding the circular bands 102 together in accordance with an embodiment of the present invention. The apparatus 200 includes multiple circular bands 102, a portion of an image 104a, 104b, 104c on each band, and one or more connecting mechanisms 202 positioned to hold the circular bands 102 in position to display an image 104. In the embodiment depicted in FIG. 2, the connecting mechanisms 202 are in the form of a pin that inserts into the circular bands 102.

In other embodiments, the connecting mechanism 202 may include a clip that holds or fastens the circular bands 102 in place relative to each other. For example, a connecting mechanism 202 may be adjacent to each circular band 102a, 102b, 102c and may connect to each circular band 102a, 102b, 102b. The connecting mechanism 202 may, for example, include a protrusion that fits in a recess or hole in each circular band 102a, 102b, 102c, may snap to each circular band 102a, 102b, 102c, may connect with a hook and loop fastener, etc.

In another embodiment, the connecting mechanism 202 includes a connecting mechanism 202 that surrounds each of the two or more circular bands 102 to hold or fasten each circular band 102a, 102b, 102c in position. For example, the connecting mechanism 202 may be similar to a barrette for hair and may include a portion that fits in front of and behind each circular band 102a, 102b, 102c with a hinge-type element at one end and a connector at another end such that the connecting mechanism 202 may be closed and pressure applied to each circular band 102a, 102b, 102c. The connecting mechanism 202 may be formed of metal, plastic, rubber, wood, or any other material known to those of skill in the art.

In one embodiment, the connecting mechanism 202 is arranged so that an image 104 is formed when the portions of an image 104a, 104b, 104c are aligned such that the connection mechanism 202 fits and when the circular bands 102a, 102b, 102c are in a different order or are rotated to a different location, the connecting mechanism 202 will not fit. In other embodiments, the connecting mechanism 202 will fit with alternate ordering or rotation. While two connecting mechanisms 202 are shown, it is understood that more or less connecting mechanisms 202 may be used and may be spaced differently than is shown. For example, the connecting mechanisms 202 may be spaced evenly around the circular bands 102. In one embodiment, the circular bands 102 include two or more images 104 and one or more connecting mechanisms 202 are included for each image 104.

FIG. 3 is a perspective view illustrating another embodiment of an apparatus 300 for displaying an image 104 with multiple circular bands 102 with the bands 102 positioned together and an interlocking mechanism 302 in accordance with an embodiment of the present invention. In the depicted embodiment, the interlocking mechanism 302 performs a function similar to the connecting mechanism 202 of the apparatus 200 of FIG. 2. The interlocking mechanism 302 in the apparatus 300 is depicted as several puzzle-like extensions from one circular band to another (e.g. band 102c to 102b).

While two interlocking mechanisms 302 are depicted, the circular bands 102 may include one, two, or more interlocking mechanisms 302. Each interlocking mechanism 302 includes an extension from a first edge 304 of one circular band (e.g. 102c) that fits a recess in an adjacent circular band (e.g. 102b). In another embodiment, each circular band 102a, 102b, 102c includes two or more interlocking mechanisms 302 with one or more extension pieces and one or more recesses. For example (not depicted), a circular band 102a may include along a first edge 304 both extension pieces and recesses and on a second edge 306 both extension pieces and recesses. The extension pieces and recesses along both the first and second edges 304, 306 may be positioned so the portions of the images 104a, 104b, 104c align to form the image 104.

In another example (not depicted), a circular band 102a may include along a first edge 304 extension pieces and on a second edge 306 recesses. The extension pieces and recesses along the first and second edges 304, 306 may be positioned so the portions of the images 104a, 104b, 104c align to form the image 104. One of skill in the art will appreciate that there are many forms of connecting mechanisms 202, interlocking mechanisms 302, and the like, separately or in combination, able to retain the circular bands 102 in place to form an image 104.

In one embodiment, the interlocking mechanism 302 is arranged so that an image 104 is formed when the portions of an image 104a, 104b, 104c are aligned such that the interlocking mechanism 302 fits, and when the circular bands 102a, 102b, 102c are in a different order or are rotated to a different location, the interlocking mechanism 302 will not fit. In other embodiments, the interlocking mechanism 302 will fit with alternate ordering or rotation.

The interlocking mechanism 302 may take many forms, such as puzzle-type pieces, connectors, locks, etc. The interlocking mechanism 302 may connect circular bands 102 by overlaying an extension over a recess, may include a twisting motion to interlock, may snap the circular bands 102 together, etc. One of skill in the art will recognize other ways for an interlocking mechanism 302 to engage and connect circular bands 102.

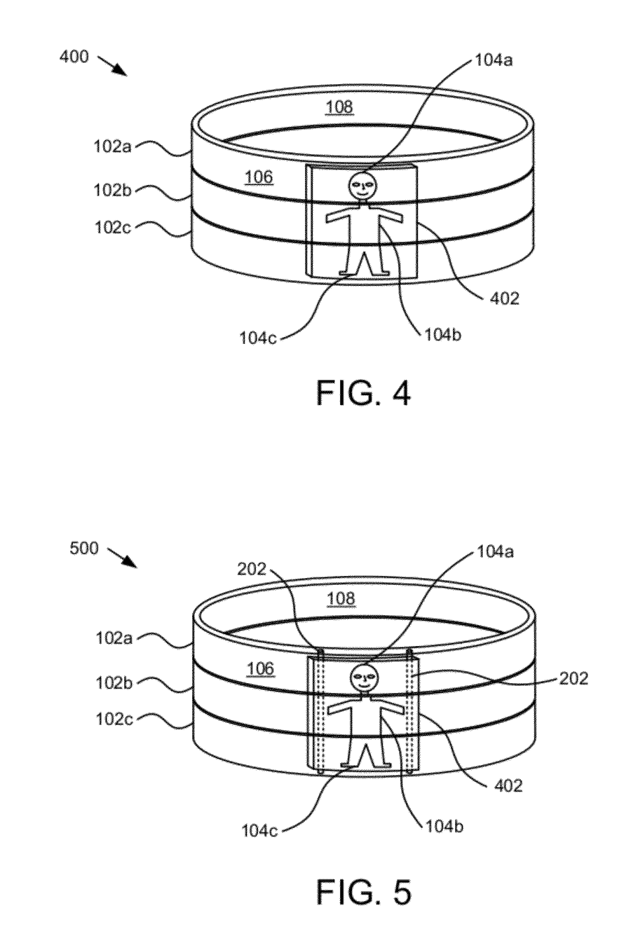

FIG. 4 is a perspective view illustrating another embodiment of an apparatus 400 for displaying an image 104 with multiple circular bands 102 with the image 104 on a raised portion 402 in accordance with an embodiment of the present invention. In the apparatus 400, each circular band 102a, 102b, 102c includes a raised portion 402 and each raised portion 402 includes a portion of the image 104a, 104b, 104c. While a simple raised portion 402 is depicted, the raised portion 402 may take on many forms. For example, the raised portion 402 may closely conform to the image 104 such that only the image 104 is raised. Another example may include multiple raised portions 402 on each circular band 102.

In another example, the raised portion 402 may be a three-dimensional image 104. In another example, the raised portion 402 may be a three-dimensional design that surrounds the circular bands 102 and one or more images 104 may be formed within the raised portion 402. One of skill in the art will recognize other ways to include at least one raised portion 402 with two or more circular bands 102 with one or more images 104 on the circular bands 102.

FIG. 5 is a perspective view illustrating another embodiment of an apparatus 500 for displaying an image 104 with multiple circular bands 102 with the image 104 on a raised portion 402 and a connecting mechanism 202 in accordance with an embodiment of the present invention. The connecting mechanism 202 and the raised portion 402 are substantially similar to those described in connection with the apparatus 200 of FIG. 2 and the apparatus 400 of FIG. 4. The raised portion 402, in one embodiment, facilitates insertion of a connecting mechanism 202 due to the raised portion 402 having a thickness that is greater than a thickness of a non-raised portion of the circular bands 102.

The raised portion 402 and connecting mechanism 202 may be integrated into one or more images 104. For example, if the image 104 includes a dinosaur skeleton, the skeleton may be three-dimensional such that bones extend from the circular bands 102 and the connecting mechanism 202 may be one or more bones that insert into the skeleton to both connect the circular bands 102 and form a portion of the dinosaur skeleton. In other embodiments (not depicted), the apparatus 500 may include an interlocking mechanism 302 as described in relation to FIG. 3.

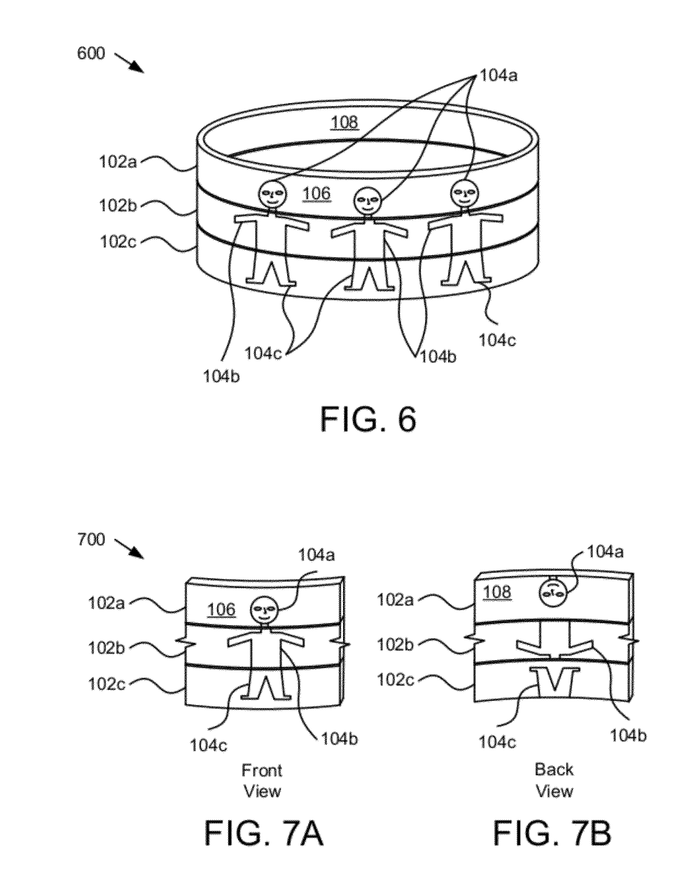

FIG. 6 is a perspective view illustrating one embodiment of an apparatus 600 for displaying two or more images 104 with a portion on each of multiple circular bands 102 in accordance with an embodiment of the present invention. In the depicted embodiment, three images 104 are depicted in the form of three characters. In other embodiments, the apparatus 600 includes images 104 that surround the exterior side 106 of the circular bands 102. The two or more images 104 may be identical, similar, or different.

In one embodiment, the images 104 are similarly spaced so that if a circular band (e.g. 102a) is rotated in relation to another circular band (102b), different images 104 are formed as each portion of an image 104a, 104b, 104c is aligned. For example, if the images 104 are cartoon characters, one circular band 102a may include heads of different cartoon characters (e.g. 104a), one circular band 102b may include a torso and arms of the cartoon characters (e.g. 104b), and one circular band 102c may include legs of the cartoon characters (e.g. 104c). When the circular band 102a with the heads 104a is rotated, a head of one cartoon character may be aligned with various torsos and arms 104b on the middle circular band 102b to form alternate forms of the cartoon characters.

In other embodiments, the multiple images 104 may be logos, designs, phrases, etc. and rotating the circular bands 102 may alter the images 104. In other embodiments (not depicted), the circular bands 102 may be re-ordered to form alternate images 104, such as mixed up characters, alternate designs, alternate phrases, and the like. One of skill in the art will recognize other ways to form multiple or alternate images 104 by rotating or reordering circular bands 102.

In one embodiment, an image 104 is formed with a collage of pictures. In the embodiment, when the portions of the image 104a, 104b, 104c are not aligned, the image 104 may not be apparent, but the image 104 becomes apparent and visible when the portions of the image 104a, 104b, 104c are aligned.

FIGS. 7A and 7B are front and back views illustrating an embodiment of an apparatus 700 for displaying images 104 where a portion of each of multiple circular bands 102 is shown. FIG. 7A depicts portion of an image 104 on an exterior side 106 of each circular band 102 and FIG. 7B depicts other portions of another image 104 on an interior side 108 of the circular bands 102. For example, where each circular band 102a, 102b, 102c includes one or more images 104 on an exterior side 106, the corresponding interior side 108 may also include images 104 which are the same or different than the images 104 on the exterior side 106.

For example, if a center circular band 102b includes arms and torsos 104b, the back side of the same circular band 102b may also include arms and torsos 104b so that if the center circular band 102b is flipped or rotated inside-out so that interior side 108 faces an exterior, the arms and torsos 104b on the interior side 108 can be aligned with the surrounding portions of images 104a, 104c to form images 104. Note that the portions of images 104b on the interior side 108 are upside-down so that when the circular bands 102 are flipped, the interior images 104 will be correctly positioned. The interior and exterior sides 106, 108 may include different characters, shapes, colors, designs, words, etc. One of skill in the art will recognize other interior images 104 compatible with exterior images 104 on circular bands 102.

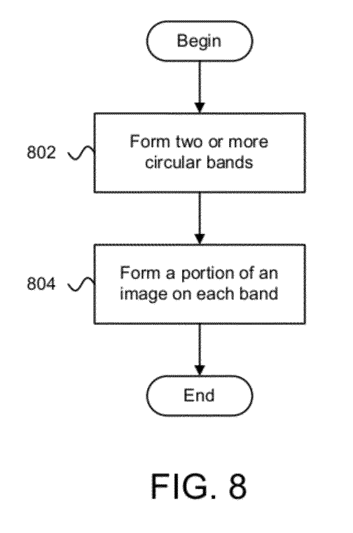

FIG. 8 is a schematic block diagram illustrating one embodiment of a method 800 for forming an image 104 on two or more circular bands 102 in accordance with the present invention. The method 800 begins by forming 802 two or more circular bands 102 sized to surround a portion of a body part and then forming 804 on an exterior side 106 of each of the two or more circular bands 102 a portion of at least one image 104, and the method 800 ends. Each of the at least one image 104 is formed 804 when the two or more circular bands 102 are positioned to be adjacent.

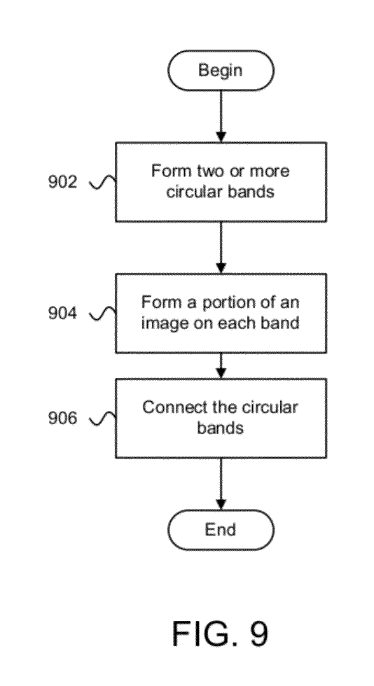

FIG. 9 is a schematic block diagram illustrating another embodiment of a method 900 for forming an image 104 on two or more circular bands 102 in accordance with the present invention. The method 900 begins by forming 902 two or more circular bands 102 sized to surround a portion of a body part and then forming 904 a portion of at least one image 104 on an exterior side 106 of each of the circular bands 102. The method 900 connects 906 the two or more circular bands 102 with a connection mechanism 202 such that the two or more circular bands 102 are adjacent and the at least one image 104 is formed, and the method 900 ends.

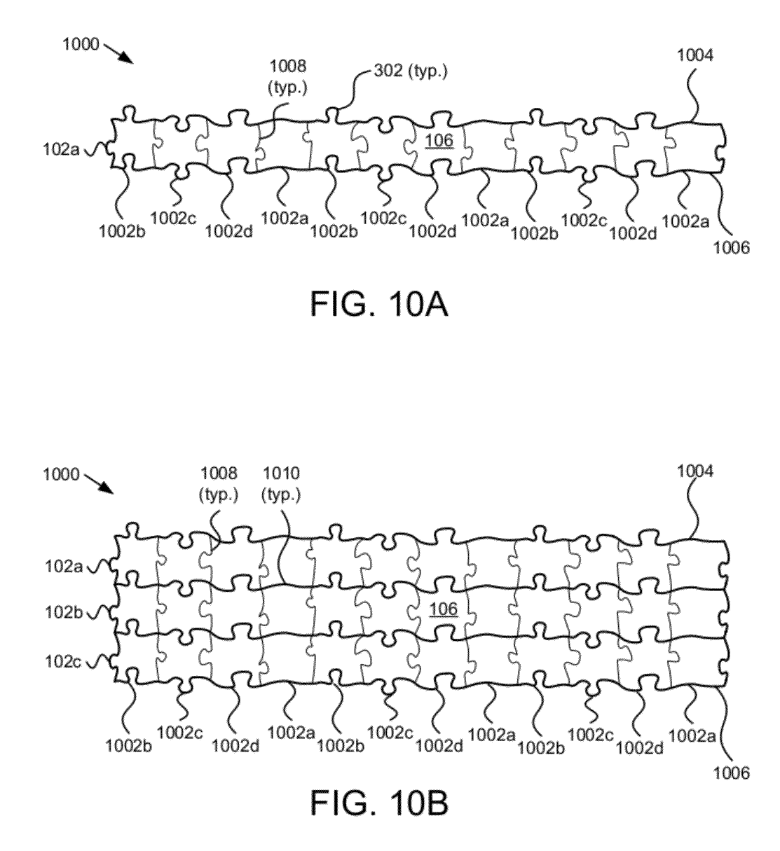

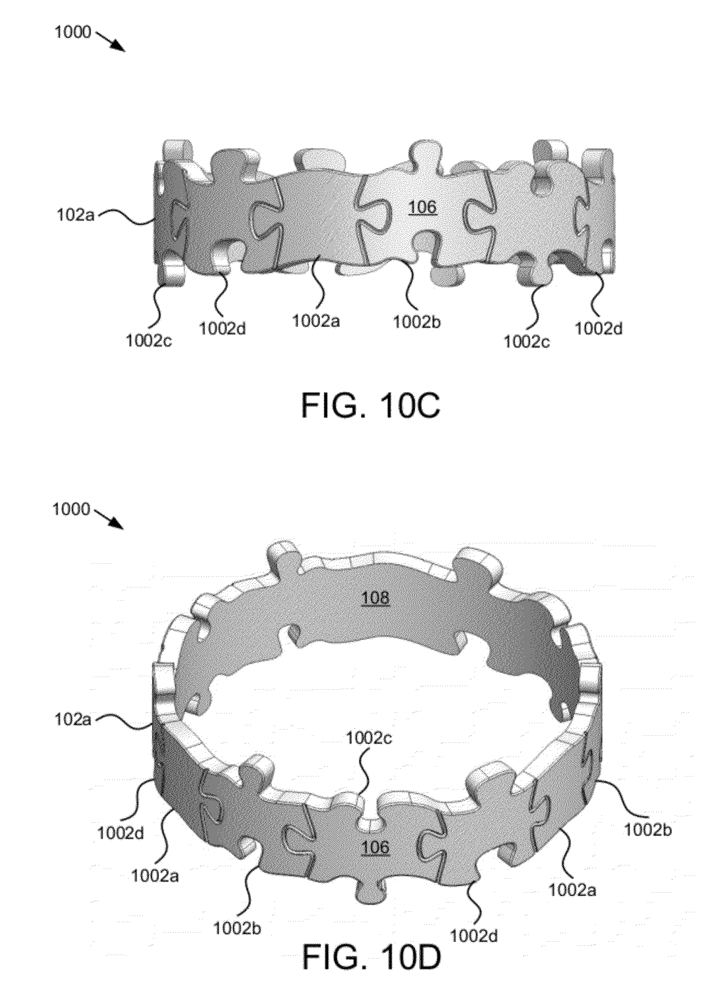

FIG. 10A is a two dimensional view and FIG. 10C is a perspective view of one embodiment 1000 of a circular band 102a for displaying an image 104 on two or more circular bands 102 in accordance with the present invention. FIG. 10B is a two dimensional view and FIG. 10D is an alternate perspective view of the circular bands 102a matching the circular band of FIGS. 10A and 10C. FIG. 10A is depicted as if the circular band 102a in FIG. 10C is cut and laid flat such that the left and right edges of the circular band 102a are typically joined together Likewise FIG. 10B is depicted as if the circular bands 102a, 102b, 102c in FIG. 10C are cut and laid flat.

In the depicted embodiment 1000, as shown in FIGS. 10A and 10C, the circular band 102a is shaped to have the appearance of puzzle pieces where the top edge 1004, bottom edge 1006, and vertical lines 1008 present an appearance of separate puzzle pieces 1002a, 1002b, 1002c, 1002d (collectively “1002”). In one embodiment, vertical lines 1008 are shaped as edges of puzzle pieces. The vertical lines 1008, in another embodiment are embossed into the circular band 102a, and in another embodiment, the vertical lines 1008 are painted onto the circular band 102a. In another embodiment, the vertical lines 1008 are a colored material formed into the circular band 102a differing from a color of the circular band 102a. In yet another embodiment, the vertical lines 1008 are cut into the circular band 102a. The cuts for the vertical lines 1008 may be partially or completely through the material of the circular band 102a. Where the cuts are completely through the circular band 102a, there may exist another means to hold the puzzle pieces 1002 together. One such example is discussed in relation to FIG. 13. One of skill in the art will recognize other means to create a vertical line 1008 in the circular band 102a to represent an edge of a puzzle piece 1002. In one embodiment, the circular bands 102a, 102b, 102c do not include vertical lines 10008.

In the embodiment 1000, the top edge 1004 and the bottom edge 1006 match to enable multiple circular bands 102a, 102b, 102c to connect together, as depicted in FIG. 10B. In one embodiment, a pattern of a bottom edge 1006 of a circular band 102a, including one or more interlocking mechanisms 302, matches a top edge 1004 of another circular band 102b to allow the circular bands 102a, 102b to connect together.

In another embodiment, the pattern along the top edge 1004 of a circular band 102a aligns with the bottom edge 1006 of the circular band 102a such that interlocking mechanisms 302 along the top and bottom edges 1004 align vertically and puzzle pieces 1002a, 1002b, 1002c, 1002d align as depicted in FIG. 10B. In another embodiment, the patterns of the top and bottom edges 1004 are offset. In such an embodiment, the puzzle pieces 1002 of a circular band (e.g. 102a) are offset from the puzzle pieces 1002 of a next band (e.g. 102b). For example one puzzle piece (e.g. 1002a) of one circular band 102a may connect to another puzzle piece (e.g. 1002b) of another circular band 102b.

In one embodiment, puzzle pieces 1002 of a circular band 102a may have a repeating pattern such. The embodiment 1000 depicted in FIGS. 10A, 10B, 10C, and 10D include a pattern of four puzzle pieces 1002a, 1002b, 1002c, 1002d repeated three times in one circular band 102a such that there are 12 puzzle pieces 1002 on the circular band 102a. Having a repeating pattern of puzzle pieces 1002 may be advantageous to enable multiple images 104 to be placed on a set of circular bands 102a, 102b, 102c so that rotating the images results in a top images 104a, such as a head, on a circular band 102a align with a different middle image 104b, such as a body, of another circular band 102b for each rotation. In the embodiment 1000 depicted in FIG. 10B, three images 104 may be placed on the set of circular bands 102 and rotated three times.

A total number of puzzle pieces 1002 divided by a total number of puzzle pieces 1002 in each rotation may be used to determine a total number of rotations. For the depicted embodiment 1000, there are 12 puzzle pieces with a pattern of four puzzle pieces (1002a, 1002b, 1002c, 1002d) so 12 divided by four is three so there are three rotations. In a design with 16 total puzzle pieces 1002 per band and four repeating puzzle pieces 1002a, 1002b, 1002c, 1002d, four rotations are possible and four images 104 may be included on a circular band 102a. Other designs may include more or fewer puzzle pieces 1002 per circular band 102 and more or fewer puzzle pieces 1002 repeated on each circular band 102 so that more or fewer images 104 may be placed and rotated on the circular bands 102.

In one embodiment, the circular bands 102 include one or more puzzle pieces (e.g. 1002a) with a substantially horizontal interface 1010 between the circular bands 102a, 102b, 102c. Having a substantially horizontal interface 1010 between the circular bands 102 may allow a simpler interface between images 104a, 104b, 104c. For example, a horizontal interface 1010 may be at a neck of a character and may facilitate a clean interface between multiple images 104. In one example, if each image 104 is a cartoon character, a substantially horizontal interface 1010 without an interlocking mechanism 302 may allow a top circular band 102a to have head images 104a of the cartoon characters while a next circular band 102b may include body images 104b of the cartoon characters.

Where the puzzle pieces 1002 are rotated from one circular band (e.g. 102a) to the next circular band (e.g. 102b), a horizontal interface 1010 of a puzzle piece (e.g. 1002a) may rotate. Such a design may include a puzzle piece 1002a a with a substantially horizontal interface 1010 along with other puzzle pieces 1002b, 1002c, 1002d with an interlocking mechanism 302 so that images 104 may be placed on puzzle pieces 1002a with a substantially horizontal interface 1010 while other puzzle pieces 1002b, 1002c, 1002d interlock to connect circular bands 102. In other embodiments, multiple puzzle pieces 1002a with a substantially horizontal interface 1010 may be used for each rotation which may allow multiple images 104 per rotation.

In one embodiment, an interface between a first and a second circular band (e.g. 102a, 102b) may differ from an interface between a second and a third circular band (e.g. 102b, 102c). In another embodiment, the interface at a top of a set of circular bands (e.g. top edge 1004 of circular band 102a) matches a bottom of the set of circular bands (e.g. bottom edge 1006 of circular band 102c). In such an embodiment, a set of circular bands 102 may connect to another set of circular bands 102 or a top circular band 102a may connect to a bottom circular band 102b if rearranged.

Having a top edge 1004 of a top circular band 102a match a bottom edge 1006 of a bottom circular band 102c while other interfaces between the circular bands (e.g. between 102a and 102b and between 102b and 102c) are different, an order of the circular bands 102 may be preserved while allowing sets of circular bands 102 to be connected. In other embodiments, a top edge 1004 of a top circular band 102a and a bottom edge 1006 of a bottom circular band 102c of a set of circular bands 102 may be flat or substantially flat or without any interlocking mechanisms 302.

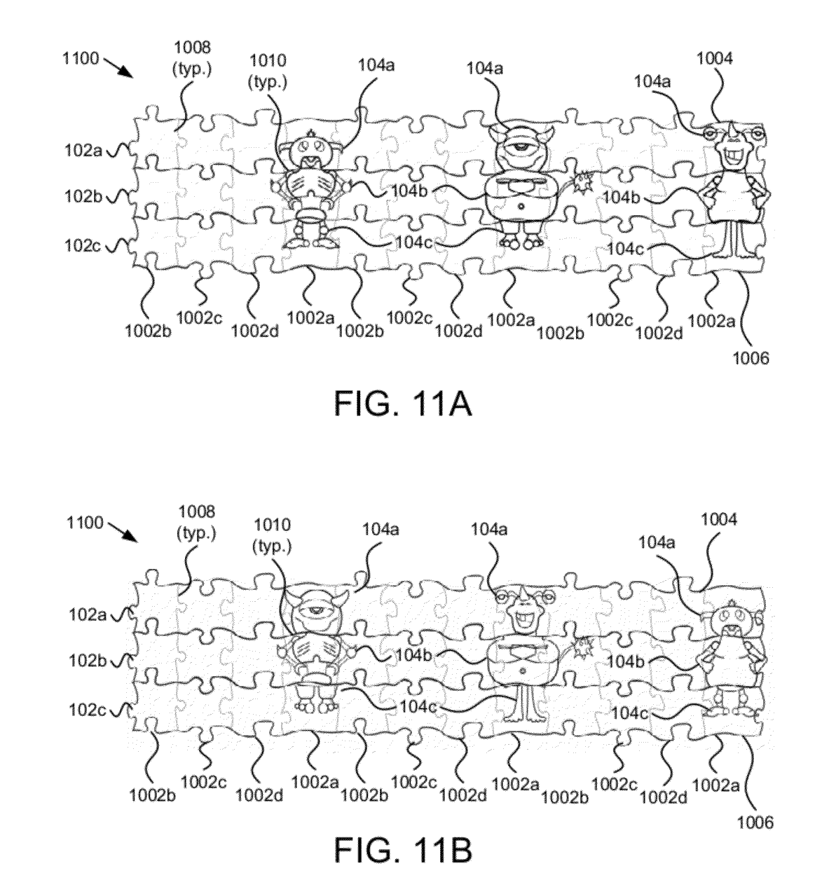

FIG. 11A is a two dimensional view of one embodiment 1100 of three circular bands 102 with three images 104 on the circular bands. FIG. 11B is a two dimensional view of the embodiment 1100 of three circular bands 102 with three images 104 on the circular bands 102 with the images 104a, 104b, 104c rotated with respect to the images 104 depicted in FIG. 11A. The embodiment 1100 includes three circular bands 102a, 102b, 102c that are substantially similar to those depicted in the embodiment 1000 of FIG. 10B except that the embodiment 1100 includes three images 104. The circular bands 102 are shown in a two dimensional format, but it is understood that the circular bands 102 may be in a form similar to the embodiment 1000 depicted in FIGS. 10C and 10D.

FIG. 11A depicts three images 104 of monsters such that for each monster each part 104a, 104b, 104c is aligned. FIG. 11B depicts the monster parts 104a, 104b, 104c rotated to create new images 104. The circular bands 102a, 102b, 102c can be each rotated three times where the third rotation returns the circular band (e.g. 102a) to its original position. Other embodiments may include more or fewer puzzle pieces 1002 and may include more or fewer images 104 and may have more or fewer rotations. While monsters are depicted, it is understood that a wide variety of images may be depicted, including cartoon characters, superheroes, robots, animals, people, designs, slogans, pictures, vehicles, etc. or parts of the various images 104. One of skill in the art will recognize other possible images, rotations, puzzle pieces 1002, etc. In one embodiment, the top edge 1004 and bottom edge 1006 of each circular band (e.g. 102a) includes a puzzle-like pattern but the circular band 102a does not include vertical lines 1008.

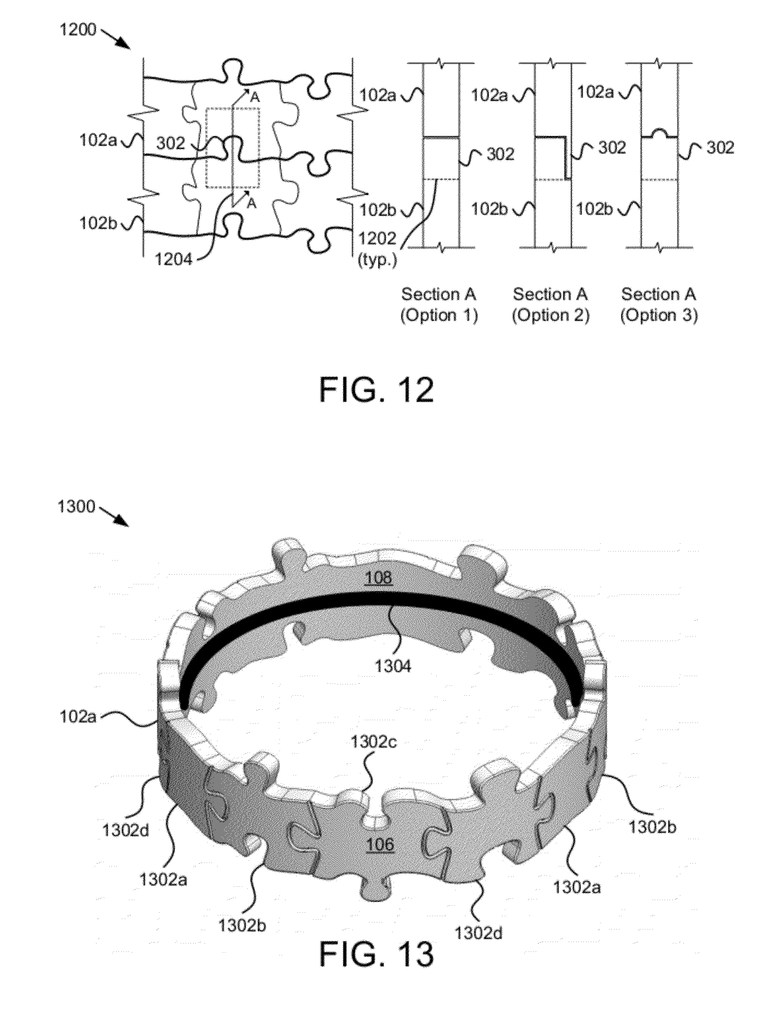

FIG. 12 is a section view 1200 of two circular bands 102a, 102b connected with an interlocking mechanism 302 and three embodiments of the interlocking mechanism 302. The portion of the circular bands 102a, 102b in the dashed box is expanded and a section A is taken through the middle of an interlocking mechanism 302 along the depicted line 1204. Three options are shown. The dashed line 1202 of each option represents the bottom of the interlocking mechanism 302 where the interlocking mechanism 302 connects to the circular band 102b. Option 1 depicts one embodiment of an interlocking mechanism 302 of the lower circular band 102b that extends completely through a recess in the upper circular band 102a. Option 1 functions to keep two circular bands 102a, 102b together by the shape of the interlocking mechanism 302 and a tight tolerance between the interlocking mechanism 302 and the recess so that the interlocking mechanism 302 fits snuggly in the recess. Where the circular bands 102a, 102b are made of a material such as silicone rubber, friction of the material also helps to prevent the interlocking mechanisms of a circular band (e.g. 102b) from pulling apart from an adjacent circular band (e.g. 102a).

Option 2 depicts an embodiment of an interlocking mechanism 302 and associated recess where the recess is not cut completely through the upper circular band 102a and a thin portion of the material of the upper circular band 102a extends across the recess forming a web across the recess. The interlocking mechanism 302 typically fills the recess and is shaped to accommodate the web across the recess. In one embodiment, the interlocking mechanism 302 is positioned toward the exterior side 106 of the circular bands 102a, 102b and the web across the recess is positioned on the interior side 108 of the circular bands 102a, 102b so that the interlocking mechanism 302 may be pushed into the recess from the exterior side 106. Elasticity of the circular bands 102a, 102b, in one embodiment, may provide a force that tends to maintain the interlocking mechanisms 302 in place while the webs across the recesses of the circular bands 102a, 102b prevent the interlocking mechanisms 302 from pushing through to the interior side 108. Tight tolerances of the recess and interlocking mechanisms 302, friction of the material of the circular bands 102a, 102b and corresponding recesses may also aid in preventing the interlocking mechanisms 302 from separating from the recesses.

Option 3 depicts an embodiment of an interlocking mechanism 302 and a corresponding recess in the circular bands 102a, 102b where the interlocking mechanism 302 includes a ridge along the edge of the interlocking mechanism 302 and the recess has a corresponding cavity. In another embodiment, the cavity may be in the interlocking mechanism 302 and the ridge may be in the recess. In other embodiments, the top edge 1004 of a circular band 102b may include a ridge and the bottom edge 1006 of an adjacent circular band 102b may include a corresponding cavity, or vice-versa. The ridge and cavity may increase adhesion between interlocking mechanisms 302 and corresponding recesses in the circular bands 102a, 102b in addition to friction of the materials used, tight tolerances, etc.

FIG. 13 is one embodiment of an apparatus 1300 for displaying an image 104 (not shown) with multiple puzzle pieces 1302a, 1302b, 1302c, 1302d (collectively “1302”) connected to an inner band 1304 in accordance with the present invention. The puzzle pieces 1302a, 1302b, 1302c, 1302d, in one embodiment, may be shaped similar to the puzzle pieces 1002 depicted in relation to FIGS. 10A, 10B, 10C, 10D, 11A, 11B. In one embodiment, the apparatus 1300 includes separate puzzle pieces 1302 that are attached to an inner band 1304 on the interior side 108 of the circular band 102a. In another embodiment, the puzzle pieces 1302 are connect to each other in addition to being connected to the inner band 1304. In another embodiment, the puzzle pieces 1302 are not interconnected to each other but are connected to the inner band 1304.

The puzzle pieces 1302, in various embodiments, are connected to the inner band 1304 with snaps, hook and loop, buttons, magnets, or any other means known in the art. In one embodiment, the puzzle pieces 1302 are each customized. For example, an owner of the apparatus 1300 may include a design, name, a picture, etc. on each puzzle piece 1302 to represent friends, children, family members, etc. In another embodiment, the puzzle pieces 1302 include images 104 that form a pattern or picture. In one embodiment, one arrangement of the puzzle pieces 1302 forms an image and correct placement of the puzzle pieces 1302 may be a game or challenge to a user, such as a child. In other embodiments, the puzzle pieces 1302 may be arranged in various ways to form alternate images for each combination. One of skill in the art will recognize other ways to attach puzzle pieces 1302 to an inner band 1304 and to create images on the puzzle pieces 1302.

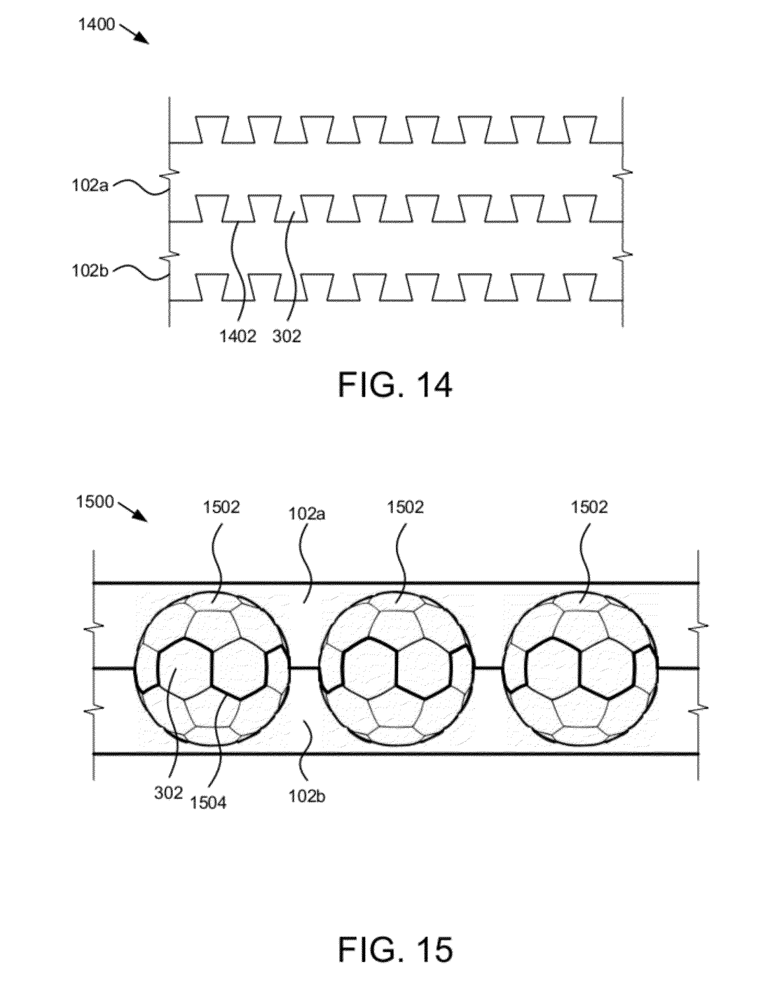

FIG. 14 is a two dimensional view 1400 of two circular bands 102a, 102b connected together with an interlocking mechanism 302 in a zigzag pattern 1402 in accordance with the present invention. The zigzag pattern 1402 may be shaped so that each interlocking mechanism 302 becomes wider as it extends from the circular band 102a, 102b to aid in preventing the interlocking mechanisms 302 from separating from corresponding recesses. In another embodiment, the circular bands 102a, 102b do not include the zigzag pattern 1402 along a top edge 1004 and bottom edge 1006 of a series of circular bands 102. In another embodiment, a zigzag pattern 1402 is included at an interface between two circular bands (e.g. 102a, 102b) while a different pattern is included at another interface between two other circular bands (e.g. 102b, 102c). One of skill in the art will recognize other patterns with interlocking mechanisms 302 and corresponding recesses to allow connecting circular bands 102 and aiding in preventing the circular bands 102 from separating.

FIG. 15 is a two dimensional view 1500 of two circular bands 102a, 102b connected together with an interlocking mechanism 302 in a soccer ball pattern 1502 in accordance with the present invention. In the embodiment, the circular bands 102a, 102b connect at lines 1504 forming the soccer balls 1502. In other embodiments, basketballs, tennis balls, footballs, may be used. In other embodiments, symbols, letters, or other images 104 may be used and the circular bands 102 may include edges that connect in lines or other locations in the images 104. One of skill in the art will recognize other images 104 that may be included on circular bands 102 such that the circular bands 102 separate within the images 104.

In one embodiment, an image 104 on the circular bands 102 includes lines to form a maze where correct placement of the circular bands 102 creates a pathway through the maze. In another embodiment, incorrect ordering of the circular bands 102 results in the maze having dead ends so there is no path through the maze. In another embodiment, as the circular bands 102 are reordered, the maze changes creating different paths. In yet another embodiment, a mouse and cheese are included in the image 104 where the mouse is at one end of the maze and the cheese along a pathway at the end of the maze. One of skill in the art will recognize other ways to configure an image 104 of a maze on circular bands 104.

In one embodiment, each circular band (e.g. 102a) has one or more images 104 associated with a person. For example, the images 104 may include a photograph, a name, a nickname, an image 104 relating to an interest of the person, and the like. In another embodiment, connection of two circular bands (e.g. 102a, 102b), where each circular band 102a, 102b is associated with a person, may represent a connection between the people associated with the circular bands 102a, 102b. For example, one circular band 102a may be associated with a husband and another circular band 102b may be associated with a wife and connecting the circular bands 102a may represent a marriage relationship between the husband and wife.

The circular bands 102 may be customized in a variety of ways. The circular bands 102 may be customized using stickers, silk screening, laser printing, engraving, etc. In other embodiments, the circular bands may be customized using attachments, such as custom puzzle pieces 1302 that connect to an inner band 1304 or with other shape, letters, etc. attached to the inner band 1304. One of skill in the art will recognize other ways to customize a circular band 102. In one embodiment, the circular bands include an image 104 that is a composite of smaller images forming a mosaic. The smaller images may be carefully colored, selected, and placed so that another image 104 is formed on the circular band 102.

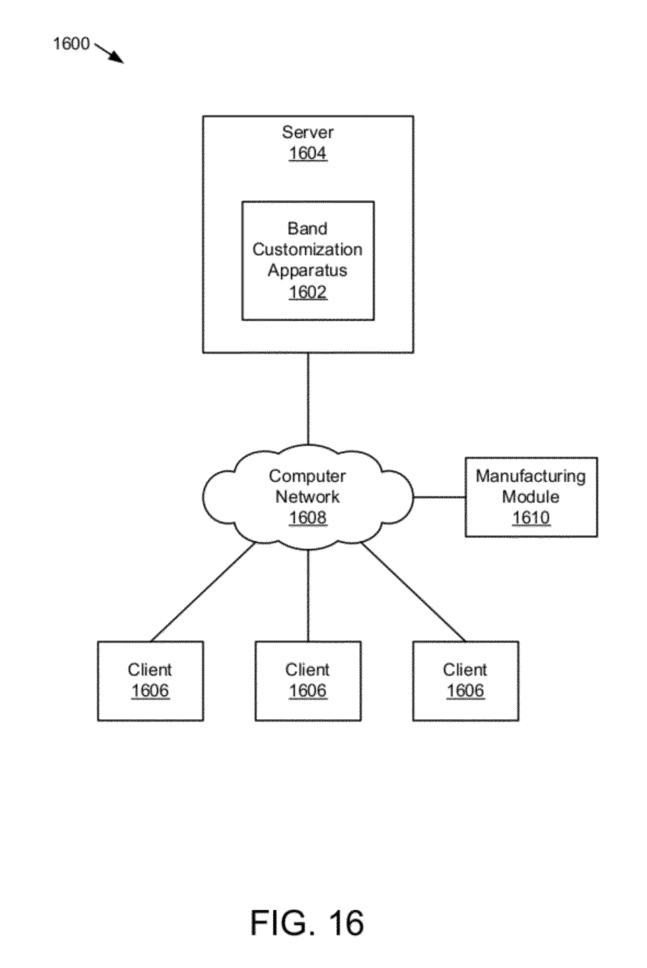

FIG. 16 is a schematic block diagram of one embodiment of a system 1600 for customizing circular bands 102 in accordance with the present invention. The system 1600, in one embodiment, includes a band customization apparatus 1602, a server 1604, clients 1606 connected to the server 1604 through a computer network 1608, and manufacturing module 1610 also connected to the server 1604 through the computer network 1608.

The server 1604 includes one or more processors. The server 1604 may be in various forms and may be a server in a rack, a mainframe computer, a workstation, a desktop computer, a laptop computer, or any other computer with a processor. The server 1604 may include data storage or may be connected to data storage through a storage area network (“SAN”) or other communication network. The server 1604, in one embodiment, includes a band customization apparatus 1602. The band customization apparatus 1602 may reside in nonvolatile memory or all or a portion may be loaded into memory for execution in a processor. In other embodiments, the band customization apparatus 1602 may include logic hardware, executable code, or both and all or a portion of the band customization apparatus 1602 may be associated with or in the server 1604.

The clients 1606 may include a desktop computer, a laptop computer, a web browser, a terminal, and the like. A client 1606 typically includes an interface for user input and may include a keyboard, a mouse, a drawing pad, a monitor, etc. A client 1606 may include hardware or software executing on a computer. In one embodiment, a user may provide information to customize a circular band 102 through a client 1606. In another embodiment, the server 1604 includes a client 1606.

The client 1606 communicates with the server 1604 with the band customization apparatus 1602 over a computer network 1608. The computer network 1608 may include the Internet, a local area network (“LAN”), a wide area network (“WAN”), a wireless LAN, a SAN, or the like and may include servers, routers, switches, cabling, etc. The manufacturing module 1610 may include a printer, a manufacturing system computer, or other means to receive circular band customization information and then to produce a customized circular band 102. In one embodiment, circular bands 102 are created in a separate process and the manufacturing module 1610 prints a customized image 104 onto a circular band 102. In another embodiment, the manufacturing module 1610 includes manufacturing equipment or a manufacturing process and the band customization apparatus 1602 transmits a customized design to the manufacturing equipment or to a manufacturer to customize a circular band 102. For example, a customized design may be emailed to a manufacturer and the manufacturer may then produce a circular band 102 with the customized design. One of skill in the art will recognize other forms of a manufacturing module 1610.

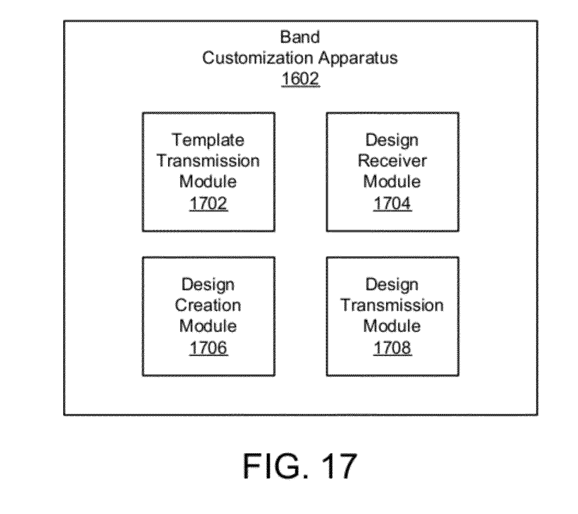

FIG. 17 is a schematic block diagram of one embodiment of a band customization apparatus 1602 for customizing circular bands 102 in accordance with the present invention. The band customization apparatus 1602 includes a template transmission module 1702, a design receiver module 1704, a design creation module 1706, and a design transmission module 1708, which are described below.

In one embodiment, the band customization apparatus 1602 includes a template transmission module 1702 that sends a circular band template to a user. The circular band template, in one embodiment, includes a pattern of a circular band 102. For example, the pattern may include lines that match puzzle pieces 1002 of a circular band so that a user may create a design within an outline of the puzzle pieces 1002. In another embodiment, the pattern of the circular band 102 includes an outline of a circular band 102 so that a user may create a design within the outline of the circular band 102. The template transmission module 1702 may send the circular band template over a computer network 1608. The circular band 102 may be substantially similar to one or more of the circular bands 102 described above in relation to FIGS. 1-15.

In one embodiment, the band customization apparatus 1602 includes a web-based application where a user may log onto a band customization website to access circular band templates for customization. In one embodiment, the band customization website may include tools to receive images, such as photographs, drawings, etc. In another embodiment, the band customization website includes tools to crop received images to match a puzzle piece (e.g. 1002a) or to match a circular band outline. In another embodiment, the band customization website includes drawing tools to add text, lines, curves, and other shapes. In another embodiment, the template transmission module 1702 sends a circular band template to a user as part of a software application that runs on a computer accessed by the user. For example, a user may purchase or acquire a band customization program that includes one or more circular band templates. One of skill in the art will recognize other tools and functions that may assist a user use a circular band template to create a custom circular band design.

In another embodiment, the band customization apparatus 1602 includes a design receiver module 1704 that receives a customized circular band design from a user. For example, if a user creates a custom circular band design using a program or a web-based application, the user may save the custom circular band design and/or transmit the custom design to the band customization apparatus 1602. For example, if a user created a custom design on a band customization website, the user may make a selection that sends the custom circular band design and the design receiver module 1704 may receive the custom circular band design.

In another embodiment, the band customization apparatus 1602 includes a design creation module 1706 that creates a circular band design in a format compatible with a manufacturing or printing process or a process for completing a circular band 102. For example, once the design receiver module 1704 receives a custom circular band design in one format, the design creation module 1706 may convert the received custom design into a different format compatible with a printing or manufacturing process. In one embodiment, the design creation module 1706 is incorporated in a way so that once a user customizes the circular band template, the resulting custom circular band design is in a format compatible with a printer or manufacturing process so that the custom circular band design received by the design receiver module 1704 is compatible with a printer or manufacturing process. For example, the band customization website may allow a user to create a JPEG (Joint Photographic Experts Group) file or other common format that can be printed or used in a manufacturing process.

In one embodiment, the design creation module 1706 creates a custom circular band design that is directly applied to the circular band 102. In another embodiment, the design creation module 1706 creates a custom circular band design that can be applied to a circular band 102, such as a sticker. In another embodiment, the design creation module 1706 creates a custom circular band design by creating custom puzzle pieces 1002 or other elements that can be attached to an inner band 1304. One of skill in the art will recognize other ways that the design creation module 1706 may create a circular band design in a format compatible with a manufacturing or printing process.

In one embodiment, the band customization apparatus 1602 includes a design transmission module 1708 that transmits a custom circular band design to a printer or a manufacturing process. For example, if a circular band 102 has been previously created, the design transmission module 1708 may transmit the custom circular band design to a printer to print directly on a circular band 102 or onto a sticker or other material that can be applied to the circular band 102. The transmission may be over a computer network 1608 or to a printer connected directly to the server 1704 with the band customization apparatus 1602.

In another embodiment, the design transmission module 1708 may transmit the custom circular band design to a manufacturing process or machine. For example, the design transmission module 1708 may transmit the custom circular band design to a manufacturer and the manufacturer may use the custom circular band design to create a custom circular band 102. In another example the design transmission module 1708 may transmit the custom circular band design to a manufacturing machine, such as a three-dimensional printer or CNC machine (computer numerical control machine). One of skill in the art will recognize other ways that the design transmission module 1708 may transmit the custom circular band design to a printer or manufacturing process.

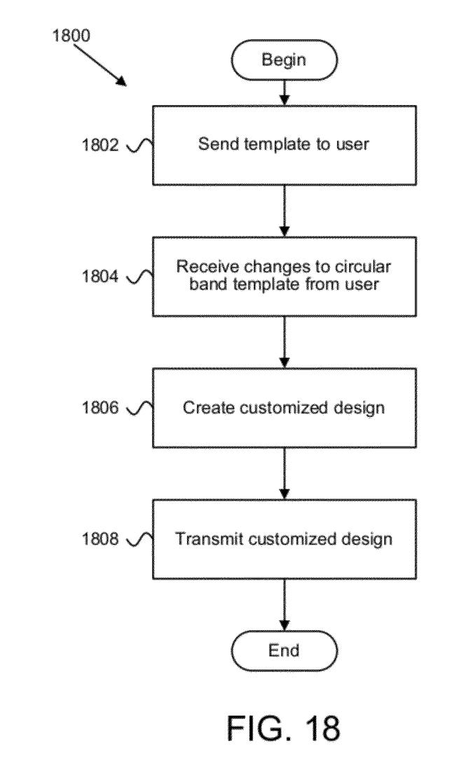

FIG. 18 is a schematic block diagram illustrating another embodiment of a method 1800 for customizing circular bands 102 in accordance with the present invention. The method 1800 begins and the template transmission module 1702 sends 1802 a circular band template to a user. The design receiver module 1704 receives 1804 a customized circular band design from a user. The design creation module 1706 creates a circular 1806 band design in a format compatible with a manufacturing or printing process. The design transmission module 1708 transmits 1808 a custom circular band design to a printer or a manufacturing process, and the method 1800 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to display an image, the apparatus comprising:
two or more circular bands sized to surround a portion of a body part; and
at least one image, wherein each of the two or more circular bands comprises a portion of the at least one image disposed on an exterior side of each circular band,
wherein the at least one image is formed when the two or more circular bands are positioned to be adjacent.

2. The apparatus of claim 1, wherein the at least one image is formed by rotating each of the two or more circular bands to a position relative to one another.

3. The apparatus of claim 1, wherein the at least one image is formed by placing each of the two or more circular bands in a particular order relative to one another.

4. The apparatus of claim 1, wherein the at least one image is formed by placing each of the two or more circular bands adjacent to one another and connecting the bands together with a connection mechanism.

5. The apparatus of claim 4, wherein the connection mechanism comprises shaping each of the two or more circular bands to interlock in a position adjacent to one another to form the at least one image.

6. The apparatus of claim 5, wherein the two or more bands interlock by way of an extension and a recess, wherein an extension from a circular band of the two or more circular bands fits into a recess of an adjacent circular band.

7. The apparatus of claim 4, wherein the connection mechanism comprises an interlocking member that is separate from the two or more circular bands and that connects the two or more circular bands such that the two or more circular bands retain a relative position to one another to form the at least one image.

8. The apparatus of claim 7, wherein the interlocking member is shaped to one or more of
insert into an opening in each of the two or more circular bands;
fasten to each of the two or more circular bands; and
surround each of the two or more circular bands.

9. The apparatus of claim 1, wherein each of the two or more circular bands comprises a portion of two or more images.

10. The apparatus of claim 9, wherein a first image is formed when the two or more circular bands are rotated to align portions of the two or more images and a second image is formed when the two or more circular bands are rotated to align different portions of the two or more images.

11. The apparatus of claim 1, wherein the at least one image comprises one or more of a character, a picture, a design, a logo, and a slogan.

12. The apparatus of claim 1, wherein one or more of the two or more circular bands comprises at least a portion of an image on an interior side such that when a circular band with at least a portion of an image on the interior side is turned inside out, the at least a portion of the image on the interior side becomes at least a portion of an image on the exterior sides of the two or more circular bands.

13. The apparatus of claim 1, wherein the two or more circular bands have a non-slip surface on at least an interior side.

14. The apparatus of claim 1, wherein the two or more circular bands comprise a material that stretches.

15. The apparatus of claim 1, wherein at least a portion of the two or more circular bands are constructed of one or more of silicone, rubber, plastic, wood, and metal.

16. The apparatus of claim 1, wherein each of the two or more circular bands further comprises at least one extension piece, wherein each extension piece comprises a portion of the at least one image.

17. The apparatus of claim 16, wherein the extension pieces each comprise a connection mechanism wherein the connection mechanism connects such that the extension pieces are bound together.

18. An apparatus for displaying an image, the apparatus comprising:
two or more circular bands sized to surround a portion of a body part;
a connection mechanism that connects the two circular bands to be adjacent; and
at least one image, wherein each of the two or more circular bands comprises a portion of the at least one image disposed on a side of each circular band,
wherein the at least one image is formed when the two or more circular bands are connected with the connection mechanism to be adjacent.

19. A method for displaying an image, the method comprising:
forming two or more circular bands sized to surround a portion of a body part; and
forming on an exterior side of each of the two or more circular bands a portion of at least one image,
wherein the at least one image is formed when the two or more circular bands are positioned to be adjacent.

20. The method of claim 19, further comprising connecting the two or more circular bands with a connection mechanism such that the two or more circular bands are adjacent and the at least one image is formed.
